(19) United States
(12) Patent Application Publication
(10) Pub. No.: US 2005/0186474 A1
(43) Pub. Date: Aug. 25, 2005

(54) Positive electrodes for lithium batteries and their methods of fabrication

(75) Inventors: Zhanfeng Jiang, Shenzhen (CN); Junqing Dong, Shenzhen (CN); Hulquan Liu, Shenzhen (CN)

Correspondence Address: EMIL CHANG;LAW OFFICES OF EMIL CHANG, 874 JASMINE DRIVE, SUNNYDALE, CA, 94086, US

(73) Assignee: BYD America Corporation

(21) Appl. No.: 11/059,433

(22) Filed: Feb. 15, 2005

(30) Foreign Application Priority Data
Feb. 17, 2004 (CN) 2004100154006

(51) Int. Cl. H01M 4/02; H01M 4/50; H01M 4/52; B05D 5/12; B05D 1/36

(52) U.S. Cl. 429/209; 429/224; 429/231.1; 429/223; 429/231.3; 427/419.1; 427/419.2; 427/58; 427/126.3; 427/126.6

(57) ABSTRACT

The present invention discloses positive electrodes and their methods of fabrication. These electrodes are low in cost. Lithium rechargeable batteries that use these positive electrodes have excellent cycling properties at high temperature. The positive electrode of the embodiments of this invention comprises of a current collector coated by two layers of active materials for positive electrodes. The active material for the first layer of coating is one or more active materials selected from the following: spinel lithium manganese oxide, and spinel lithium manganese oxide derivatives. The active material for the second layer of coating is one or more active material selected from the following: lithium cobalt oxide, lithium cobalt oxide derivatives, lithium nickel oxide, and lithium nickel oxide derivatives. To fabricate these positive electrodes, a first layer of coating comprising of the active materials stated above is applied onto a current collector and then dried before a second layer of coating is applied onto the surface of the first layer of coating. The positive electrode is obtained after the current collector with the two layers of coating is dried a second time and then pressed to form a slice.

### CROSS REFERENCE

This application claims priority from a Chinese patent application entitled “Positive Electrodes for Lithium Batteries, Their Methods of Fabrication and Lithium Ion Secondary Batteries” filed on Feb. 17, 2004, having a Chinese Application No. 2004100154006. This Chinese application is incorporated herein by reference in its entirety.

### FIELD OF THE INVENTION

This invention relates to positive electrodes for lithium batteries and the methods of fabrication of these positive electrodes. Batteries using these positive electrodes have better cycling capacity at high temperature.

### BACKGROUND

In recent years, with increasing demands on energy supplies and the increased awareness for environmental protection, environmental friendly vehicles such as electric automobiles and electric bicycles etc. are receiving more attention and efforts are being made to make these products practical. As energy sources for electric vehicles, batteries must have large capacities and excellent cycling properties. Lithium rechargeable batteries have been favorably accepted as they have the following advantages: high voltage, lightweight, no memory effect, long cycling life and non-polluting.

Active materials for positive electrodes of rechargeable lithium batteries use metal compounds that embed or detach lithium ions. The commonly used materials include LiCoO₂, LiMnO₂, LiNiO₂, LiNi₁₋ₓCoₓO₂ (0<x<1) and LiMn₂O₄.

Among these materials, lithium cobalt oxide (LiCoO₂) and lithium nickel oxide (LiNiO₂) etc. have higher specific discharge capacities. Therefore, they are more desirable and practical and are more widely accepted for use in batteries. Today, most lithium rechargeable batteries that are manufactured use LiCoO₂ as the active material for the positive electrode. However, this material is very expensive and its supply is limited. In addition, its decomposition temperature after charging is low, and its thermal stability is poor.

Manganese based active materials for positive electrodes that are rich in manganese such as oxides of lithium (spinel lithium manganese oxide, LiMn₂O₄) are easy to fabricate, cheap, have high thermal stability during charging, and environmentally friendly. When compared with other active materials for positive electrodes, the spinel lithium manganese oxide can satisfy the demands of power batteries from the cost, resources and safety perspectives. However, the attenuation of their capacities at high temperature (60° C.) severely limits their use in industrial applications.

The main causes for the rapid attenuation of the capacity of spinel lithium manganese oxide at high temperature include: the dissolution of Mn, the Jahn-Teller effect, and the volume change of the crystal cells when lithium ions detach and embed.

Disproportionation, as represented by the following: 2Mn³⁺(solid)→Mn⁴⁺(solid)+Mn²⁺(solution), occurs easily on the surface of spinel lithium manganese oxide granules. In a battery, the Mn²⁺dissolves in the electrolyte, is reduced to Mn, and deposits on the surface of the negative electrode. The loss of the Mn not only causes instability of the spinel crystal structure but also accelerates the substitution between the H⁺ions and the Li⁺ions to form the protonation phase Li_{1-2y}Mn_{2-y}O₄. As a result, the material can only partially detach and embed lithium. In addition, the polarization is also increased, causing a reduction in capacity.

The electron group type of Mn in spinel lithium manganese oxide is d⁴. Because these d electrons occupy the d orbit that is split under octahedral field impact unevenly, they cause the octahedral oxygen to deviate from a global symmetry and distort into a metamorphous octahedral structure. This is the so-called Jahn-Teller effect. This effect is especially apparent when during over discharging when the voltage is below 3V and the Li embeds in the spinel lithium manganese oxide to form Li₁₊ₓMn₂O₄. This leads to its transformation from a cubic crystal to a tetragonal crystal. The structural incompatibility when these two phases coexist results in poor contact between the granules of materials of the electrodes. As a result, it is difficult for the lithium ions to diffuse. The volume change from the transformation of the cubic crystal to tetragonal crystal also results in the reduction of capacity.

Tests have shown that the dissolution of Mn and the Jahn-Teller effect occur mainly at the end of the discharging of the materials. At that time, localized over-discharge can easily occur on the surface of the granules of the spinel lithium manganese oxide on the surface of the electrodes. This phenomenon causes the quantivalency of Mn in those areas to be lower than +3.5, the average quantivalency of Mn. When that happens, the dissolution of Mn and the Jahn-Teller effect can easily occur. Cycling at high temperature will increase the effects of these two processes that are the primary cause of attenuation in the capacity of a battery.

Due to the limitations of the prior art, it is therefore desirable to have novel positive electrodes and methods of fabrications for these positive electrodes that are not only low in cost but also, when used in batteries, produces batteries with excellent cycling properties at high temperature.

### SUMMARY OF THE INVENTION

An object of this invention is to provide positive electrodes that are low in cost.

Another object of this invention is to provide positive electrodes such that, when these positive electrodes are used in lithium rechargeable batteries, the batteries have excellent cycling properties at high temperature.

Another object of this invention is to provide methods of fabrication of positive electrodes for lithium rechargeable batteries that are low in cost and, when used in lithium rechargeable batteries, produces batteries with excellent cycling properties at high temperature.

Briefly, the present invention relates to positive electrodes for lithium rechargeable batteries and their methods of fabrication. The positive electrode of the embodiments of this invention comprises of a current collector coated by two layers of active materials for positive electrodes. The active material for the first layer of coating can be one or more active materials selected from the following: spinel lithium manganese oxide, and spinel lithium manganese oxide derivatives. The active material for the second layer of coating can be one or more active material selected from the following: lithium cobalt oxide, lithium cobalt oxide derivatives, lithium nickel oxide, and lithium nickel oxide derivatives. To fabricate these positive electrodes, a first layer of coating comprising of the active materials stated above is applied onto a current collector and then dried before a second layer of coating is applied onto the surface of the first layer of coating. The positive electrode is obtained after the current collector with the two layers of coating is dried a second time and then pressed to form a slice.

An advantage of this invention is that the positive electrodes of this invention or fabricated by methods of this invention are low in cost.

Another advantage of this invention is batteries with the positive electrodes that are embodiments of this invention or fabricated by methods that are embodiments of this invention, have excellent cycling properties at high temperature.

### DESCRIPTION OF THE DRAWINGS

The foregoing and other object, aspects and advantages of the invention will be better understood from the following detailed description of preferred embodiments of this invention when taken in conjunction with the accompanying drawings in which:

FIG. 1 is a view of a cross section of a positive electrode that is an embodiment of this invention and that is fabricated by a method that is also an embodiment of this invention.

FIG. 2 is a view of a local cross section of a lithium rechargeable battery whose positive electrode is an embodiment of this invention.

### DETAILED DESCRIPTION OF THE INVENTION AND PREFERRED EMBODIMENTS

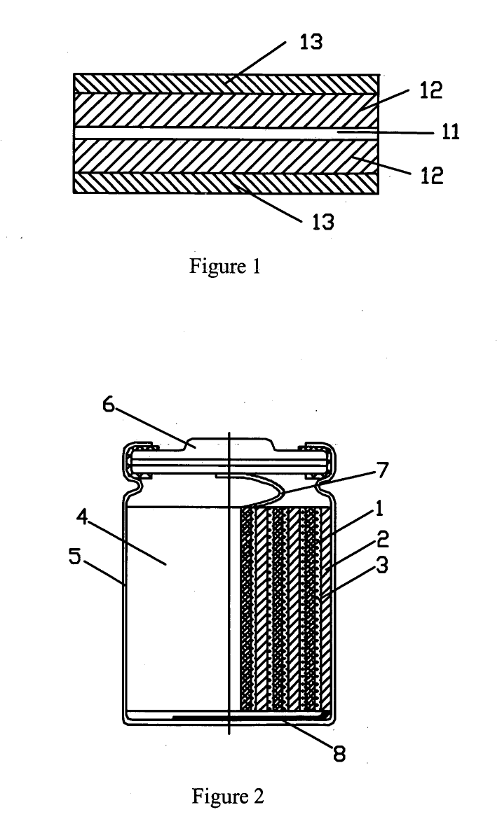

The presently preferred embodiments of positive electrodes of lithium rechargeable batteries of the present invention comprise of a current collector, a first layer of coating on the current collector, and a second layer of coating coated on the said layer. FIG. 1 shows the schematic diagram of a cross section of an embodiment where the current collector (11) is coated with a first layer of coating (12) and a second layer of coating (13). The active material for the first layer of coating can be one or more active materials of positive electrodes selected from the following: lithium manganese oxide, and lithium manganese oxide derivatives. The active material for the first layer of coating in the preferred embodiments can be one or more active materials of positive electrodes selected from the following: spinel lithium manganese oxide, and spinel lithium manganese oxide derivatives. The active material for the second layer of coating can be one or more active materials of positive electrodes selected from one of following: lithium cobalt oxide, lithium cobalt oxide derivatives, lithium nickel oxide and lithium nickel oxide derivatives. Hereinafter, lithium manganese oxide, lithium manganese oxide derivatives, or their mixtures, including spinel lithium manganese oxide, spinel lithium manganese oxide derivatives, or their mixtures shall be called lithium manganese oxide materials. Lithium cobalt oxide, lithium cobalt oxide derivatives, or their mixtures shall be called lithium cobalt oxide materials; and lithium nickel oxide, lithium nickel oxide derivatives, or their mixture, shall be called lithium nickel oxide materials.

The preferred methods of the present invention for fabricating a positive electrode of lithium batteries comprise the steps of: applying a first layer of coating on a current collector to obtain electrode with a first layer of coating, drying with heat, applying a second layer of coating on the first layer of coating to obtain electrodes with a second layer of coating, drying with heat, and pressing to form a slice to obtain the positive electrode. The active material for the first layer of coating can be one or more active materials of positive electrodes selected from the following: lithium manganese oxide, and lithium manganese oxide derivatives. The active material for the first layer of coating in the preferred embodiments can be one or more active materials of positive electrodes selected from the following: spinel lithium manganese oxide, and spinel lithium manganese oxide derivatives. The active material for the second layer of coating can be one or more active material of positive electrodes selected from one of following: lithium cobalt oxide, lithium cobalt oxide derivatives, lithium nickel oxide and lithium nickel oxide derivatives.

Lithium rechargeable batteries with positive electrodes that are embodiments of this invention or is fabricated with methods that are embodiments of this invention comprise of a positive electrode, a negative electrode, a separation membranes between said positive electrode and negative electrode, and the electrolyte.

When compared with existing technologies for positive electrodes, embodiments of this invention are cheaper as they use manganese based active materials as active materials for positive electrodes.

Another unique feature of the embodiments of this invention is that the positive electrodes comprise of lithium manganese oxide materials coated with lithium cobalt oxide materials or lithium nickel oxide materials, or their mixtures. By doing so, the over-discharge area is separated from the lithium manganese oxide material. This separation prevents localized over discharge on the surface of the granules of lithium manganese oxide materials. This effectively decreases occurrences of the dissolution of Mn and Jahn-Teller effect; thus reducing the rapid attenuation of the capacity of the materials at high temperature.

In the preferred embodiments of this invention, the active material for positive electrodes in the first layer of coating can be one or more active materials selected from the following: the spinel lithium manganese oxide, and the spinel lithium manganese oxide derivatives. These lithium manganese oxide materials include lithium compounds represented by the chemical formula, Li₁₊ₐMn_{2-b}N_{b}O₄.

In the preferred embodiments, the variables in the formula can be limited by the following conditions: 0.15≦a≦0.15, 0≦b≦0.5, and N can be one or more elements selected from the following group: Mg, Ca, Sr, Ba, Ti, Cr, Fe, Co, Ni, Cu, and Al. The detailed description of specific embodiments described in this specification use LiMn₂O₄ and LiMn_{1.75}Co_{0.25}O₄ as the active materials for positive electrodes for the first layer of coating. It should also be noted that other spinel lithium manganese oxide derivatives corresponding to the formula Li₁₊ₐMn_{2-b}N_{b}O₄, their mixtures, or their mixtures with other mixtures of lithium manganese oxide materials are also materials that can be used for this first layer of coating.

The active materials for positive electrodes in the second layer of coating are selected from lithium compounds or their mixtures represented by the following formulas:
LiCo₁₋ₓMₓO₂;
LiNi_{1-y}M_{y}O₂.

In the formulas, 0≦x≦0.2, 0≦y≦0.5, and M can be selected from at least one of following elements: Mg, Ca, Sr, Ba, Ti, Cr, Mn, Fe, Ni, Co, Cu, and Al. The embodiments that are described in detail in this specification LiCoO₂, LiCo_{0.99}Al_{0.01}O₂ and LiNi_{0.8}Co_{0.2}O₂ as the active materials for positive electrodes in the second layer of coating. It should be noted that other lithium cobalt oxide derivatives, lithium nickel oxide derivatives, represented by the formulas LiCo₁₋ₓMₓO₂ or LiNi_{1-y}M_{y}O₂, or their mixtures, are also materials that can be used for this second layer of coating.

To fabricate an embodiment of this invention, the paste for the first and second layer of coating has to be fabricated. For each layer of coating, the fabrication comprises of the following steps:

dissolving the binding agent for the specific layer of coating in solvent;

adding the active materials for the specific layer of coating; and

stirring the mixture at between 300 rpm and 600 rpm for between 0.2 hour and 10 hours to mix.

The solvent used in these embodiments can be any solvent that is commonly used in such mixtures of active materials for positive electrodes. Examples of solvents that can be used are N-methyl pyrrolidone, dimethyl formamide, anhydrous ethanol, etc. The embodiments that are described in detail in this specification use N-methyl pyrrolidone. The quantity of solvent and active material for positive electrodes are these embodiments need not be specified precisely. However, a sufficient quantity should be used to produce a paste with a suitable viscosity such that the paste is easily coated onto the current collector. Said binding agents include any binding agents that are commonly used in regular mixtures of active materials for positive electrodes; as long as the binding agent selected can be dissolved in the solvent used. Examples of binding agents that can be used are fluororesins such as polytetrafluoro ethylene, polyvinylidene fluoride etc., and polythene, polyvinyl alcohol etc. Polyvinylidene fluoride is used in the embodiments described in detail herein in this specification. The mixtures of the active materials for positive electrodes in the embodiments herein also include conducting agents that strengthen the conductivity of the batteries. These conducting agents can be any conducting agents commonly used for improving the conductivity of the mixture of active materials for positive electrodes. Examples of conducting agents are: carbon black, graphite-like carbon materials. Acetylene black is used in the embodiments described in detail herein.

The current collectors in the embodiments of this invention whose surface is coated by the first layer of coating can be fabricated from any conductive material that is inert in the lithium battery environment. They can either mesh or foil. Examples are: aluminum foil, stainless steel foil, and nickel foil. Aluminum foil is used in the embodiments that are described in detail herein.

The paste of the mixture of active materials for positive electrodes for the first layer of coating is coated onto both sides of a current collector (11) to obtain electrodes coated with the first layer of coating (12). After drying with heat, the first layer of coating (12) is then coated with a second layer of coating on both sides of the collector to obtain the electrodes with the second layer of coating (13). See FIG. 1. After drying with heat and pressing to form a slice, the electrode is then cut to the desired size to obtain the positive electrode. A view of a cross section of a positive electrode of an embodiment is shown in FIG. 1. It shows that there are two layers of the first layer of coating, one on each side of the collector. Similarly, there are two layers of the second layer of coating, one on each side of the collector. The single sided thickness of a coating referred to herein is the thickness of that layer of coating on one side of the current collector. Thus, the single sided thickness of the first layer of coating in the embodiment as depicted in FIG. 1 is the thickness of one of the two layers of first layer of coating (12). Similarly, the single sided thickness of the second layer of coating in the embodiment as depicted in FIG. 1 is the thickness of one of the two layers of second layer of coating (13).

The single sided thickness of the first layer of coating in embodiments of this invention is between 0.02 mm and 0.15 mm. The optimal range is between 0.05 mm and 0.12 mm. The single sided thickness of the second layer of coating is between 0.01 mm and 0.06 mm. Its optimal range is between 0.02 mm and 0.04 mm. The thickness of layers of coating is determined by the type of battery to be produced.

If the single sided thickness of the second layer of coating is specified to be lower than 0.02 mm, then, before the second coating is put on, the electrodes obtained after the first coating should be pressed.

Dip coating is the coating method used in the embodiments of this invention. Other coating methods such as spray coating or brush coating etc. can also be used for the two layers of coating.

In order to take advantage of the low cost, abundance, and excellent safety properties of the lithium manganese oxide materials, embodiments of this invention should maximize the use of the lithium manganese oxide materials. However, if too much of the lithium manganese oxide materials are used, the electrodes would become too thick after the second coating. As a result, this will prevent the electrolyte from thoroughly soaking and penetrating the electrode and hinder the migration of lithium ions. It is preferable that the single sided thickness of the first layer of coating to be between 0.02 mm and 0.15 mm. The optimal range for the single sided thickness of the first layer of coating is between 0.05 mm and 0.12 mm.

Similarly, if the second layer of coating is too thin to thoroughly cover the lithium manganese oxide material, it cannot prevent the occurrence of localized overcharge of the lithium manganese oxide material. On the other hand, if the second layer of coating is too thick, the increase use of material will increase the cost of the battery. In addition, when the electrode is too thick, the electrolyte cannot thoroughly soak and penetrate the electrode. This will hinder the migration of the lithium ions. In the embodiments of this invention, the single sided thickness of the second coating should be between 0.01 mm and 0.06 mm. The optimal range for the single sided thickness of the second layer of coating is between 0.02 mm and 0.04 mm.

In summary, in order for batteries with embodiments of this invention as positive electrodes to have excellent overall electrical properties, the sum of the single sided thickness of the first layer of coating and the single sided thickness of the second layer of coating should be set appropriately. If the total thickness of two layers of coating is too thin, the capacity of the resulting battery is reduced due to the small amount of active material available for the positive electrode. If the total thickness of the two layers of coatings is too thick, the electrolyte will not be able to thoroughly soak and penetrate the electrode. This will hinder the migration of the lithium ions and affect the electrical properties of the battery. Therefore, the sum of single sided thickness of the first and the second layers of coating in the embodiments should be between 0.08 mm and 0.20 mm. The optimal range is between 0.10 mm and 0.16 mm.

After the second layer of coating is coated on but before it is dried, the solvent in the paste of this second layer can dissolve the lithium manganese oxide material from the first coating. This will form a thin layer of mixture from the lithium manganese oxide material and lithium cobalt oxide or lithium nickel oxide material between the first and the second layers of coating. In practice, the thickness of the second layer of coating should be larger than that of this mixture layer to ensure that no granules of lithium manganese oxide material exist at the surface of positive electrode plate. Therefore, if the second layer of coating is relatively thin, the electrodes from the first coating should undergo pressing treatment, in order to reduce the distance between the granules of lithium manganese oxide material and increase the binding power among the granules. This will reduce the amount of the materials from the first layer of coating that will be dissolved in the solvent from the second layer of coating. Embodiments require the pressing of the electrodes obtained after the first coating if the single sided thickness of the second layer of coating is less than 0.02 mm. If the single sided thickness of the second layer of coating is greater than 0.02 mm, the pressing of the electrodes between the first and second coating is not necessary. However, pressing between the two coatings will produce positive electrodes with better electrical properties.

In order to test the properties of the positive electrodes that are embodiments of this invention, lithium rechargeable batteries using said positive electrodes are fabricated. The negative electrodes for said lithium batteries are fabricated by stirring and mixing active materials for negative electrodes with their corresponding binding agents, dispersing agents and solvents to form a paste. The paste is coated on the current collectors, then dried with heat and pressed to form the negative electrode slices. The active material for said negative electrodes include any commonly used active materials for negative electrodes. Lithium metal, lithium alloy or materials that can embed and detach lithium ions etc. are examples of active materials that can be used. Materials that can embed and detach lithium ions such as natural graphite, artificial graphite, coke,.carbon black, pyrolytic carbon, carbon fiber, products from the calcinations of organic polymers, sulfur compounds such as oxides and sulfides that can embed and detach lithium ions at lower potential than the positive electrode, and carbonaceous materials, mainly comprising of graphite materials (such as natural graphite and artificial graphite) are also suitable. Batteries made with positive electrodes that are embodiments described in detail herein (“testing batteries”) use natural graphite.

The binding agents used in said batteries include any commonly used binding agents for regular mixtures of active materials for negative electrodes. They can be fluororesins such as polytetrafluoro ethylene, polyvinylidene fluoride etc., polythene, and polyvinyl alcohol etc. Testing batteries use polyvinylidene fluoride. Dispersing agents can be cellulose. Said solvents include any commonly used solvents for regular mixtures of active materials for negative electrodes. They can be N-methyl pyrrolidone, dimethyl formamide, anhydrous ethanol, and deionized water. Testing batteries use N-methyl pyrrolidone. Current collectors that are used in the negative electrodes can be either mesh or foil. They can be copper foil, stainless steel foil, or nickel foil. The negative electrodes in the testing batteries use copper foil.

The electrolyte of said batteries is a non-aqueous electrolyte. The salts used in said electrolyte can be any typical non-aqueous electrolyte. Examples are: lithium salts such as LiPF₆, LiBF₄, LiAsF₆, LiClO₄, LiSbF₆, LiCl, LiBr, LiCF₂SO₃ etc. To achieve stability against oxidization, the optimal selections are LiClO₄, LiPF₆, LiBF₄ and LiAsF₆. The electrolyte in the testing batteries is lithium hexafluorophosphate LiPF₆. The solvents used are organic solvents and can be one or more the following: methyl carbonate, propene carbonate, ethanediyl ester carbonate, carbono propanediyl ester, dimethyl carbonate, diethyl carbonate, 1,1 or 1,2-dimethoxyethane, 1,2-diethoxyethane, tetrahydrofuran, 2-Methyltetrahydrofuran, Phenyl methyl ether, ether, N-methyl pyrrolidone, dimethyl formamide, acetonitrile, propanenitril, chloroacetonitrile, ethyl acetate. Solvents used in said testing batteries are a mixture of the organic solvents: methyl carbonate, ethanediyl ester carbonate and diethyl carbonate.

The separation membrane used for said lithium rechargeable batteries can be non-woven fabric or artificial resin micro-pore membrane. The optimal selection for these membranes is an artificial resin micro-pore membrane. Polyolefine micro-pore membranes, such as polyethylene micro-pore membrane, polypropylene micro-pore membrane, and compound of polyethylene and polypropylene micro-pore membrane are the best. Said testing batteries use polyethylene and polypropylene compound micro-pore separation membranes.

FIG. 2 shows an example of a lithium rechargeable battery assembled with a positive electrode that is an embodiment of this invention. The battery includes electrode group 4 comprising of said positive electrode 1, a negative electrode 2, a separation membrane 3, the and electrolyte in a battery shell 5, and sealed by the battery cover plate 6. The positive electrode 1 has a terminal lead 7 connected to the battery cover plate 6 and the negative electrode 2 has a terminal lead 8 connected to the battery shell 5. It should be understood that said embodiment, the positive electrode 1, can be used to produce other types of lithium batteries.

The lithium rechargeable batteries assembled from said positive electrodes that are embodiments of this invention, negative electrodes, electrolyte and separation membranes, have the advantages of being low in cost, excellent thermal stability, and less attenuation of capacities at high temperature.

The following embodiments further describe this invention.

Embodiment 1

In this embodiment, publicly known methods are used to fabricate the spinel lithium manganese oxide LiMn₂O₄ and lithium cobalt oxide LiCoO₂.

95 wt % of the spinel lithium manganese oxide, 2 wt % of the binding agent polyvinylidene fluoride, PVDF, 3 wt % of the conducting agent acetylene black, and the solvent N-methyl pyrrolidone, NMP, are mixed uniformly together and stirred at a rate of 1000 rpm for 4 hours to obtain the paste for the first layer of coating.

Substituting lithium cobalt oxide for spinel lithium manganese oxide and using the same quantities of materials proscribed, the above described process for producing the paste for the first layer of coating is repeated to obtain the paste for the second layer of coating.

Using the dip coating method, the paste of the spinel lithium manganese oxide for the first layer of coating is coated onto a current collector. The single sided thickness of this first layer of coating is 0.115 mm. This first layer of coating is then dried with heat and pressed to form a slice.

After the first coating, using the dip coating method, the paste of lithium cobalt oxide for the second layer of coating is coated onto the first layer of coating. The single sided thickness of this second layer of coating is 0.005 mm. This coating is then dried with heat, pressed to form a slice, and then cut to the desired size to size to obtain the positive electrode slice.

To fabricate the negative electrode of the battery, 94 wt % of natural graphite, 5 wt % of the binding agent polyvinylidene fluoride PVDF, 1 wt % of the dispersing agent cellulose, and the solvent N-methyl pyrrolidone NMP are mixed uniformly together and stirred at a rate of 1000 rpm for 4 hours. The mixture is then coated on, dried with heat and pressed into a slice and cut into the desired size to form the negative electrode slice.

The winding style lithium rechargeable battery used for the testing the properties of the positive electrode of this embodiment uses said positive electrode slice, negative electrode slice, lithium hexafluorophosphate, LiP₆ as electrolyte, a mixture of the organic solvents of methyl carbonate, ethanediyl ester carbonate and diethyl carbonate at 1 mol/l concentration as solvent, polyethylene, and polypropylene compound micro-pore separation membranes as separation membranes.

Embodiment 2

In this embodiment, the single sided thickness of the first layer of coating is 0.110 mm, and the single sided thickness of the second layer of coating is 0.010 mm. Except for the above, all other processes remain the same as in Embodiment 1.

Embodiment 3

In this embodiment, the single sided thickness of the first layer of coating is 0.110 mm. After the first coating, the current collector with the first layer of coating is not pressed. The single sided thickness of the second layer of coating is 0.010 mm. Except for the above, all other processes remain the same as in Embodiment 1.

Embodiment 4

In this embodiment, the single sided thickness of the first layer of coating is 0.100 mm, and single sided thickness of the second layer of coating is 0.020 mm. Except for the above, all other processes remain the same as in Embodiment 1.

Embodiment 5

In this embodiment, the single sided thickness of the first layer of coating is set as 0.100 mm. After the first coating, the current collector with the first layer of coating is not pressed. The single sided thickness of the second layer of coating is 0.020 mm. Except for the above, all other processes remain the same as in Embodiment 1.

Embodiment 6

In this embodiment, the single sided thickness of the first layer of coating is 0.080 mm. After the first coating, the current collector with the first layer of coating is not pressed. The single sided thickness of the second layer of coating is set as 0.040 mm. Except for the above, all other processes remain the same as in Embodiment 1.

Embodiment 7

In this embodiment, the single sided thickness of the first layer of coating is 0.060 mm. After the first coating, the current collector with the first layer of coating is not pressed. The single sided thickness of the second layer of coating is set as 0.060 mm. Except for the above, all other processes remain the same as in Embodiment 1.

Embodiment 8

In this embodiment, the lithium cobalt oxide derivative LiCo_{0.99}Al_{0.01}O₂, fabricated by publicly known methods, is used instead of the lithium cobalt oxide in Embodiment 5. Except for the above, all other processes remain the same as in Embodiment 5.

Embodiment 9

In this embodiment, the lithium nickel oxide derivative LiNi_{0.8}Co_{0.2}O₂, fabricated by publicly known methods, is used instead of the lithium nickel oxide in Embodiment 5. Except for the above, all other processes remain the same as in Embodiment 5.

Embodiment 10

In this embodiment, the lithium manganese oxide derivative LiMn_{1.75}Co_{0.25}O₄, fabricated by publicly known methods, is used instead of the spinel lithium manganese oxide in Embodiment 5. Except for the above, all other processes remain the same as in Embodiment 5.

Comparison Example

In this comparison example, the current collector is dip coated only once with spinel lithium manganese oxide. The single sided thickness of this layer of coating is 0.120 mm. Except for the above, all other processes remain the same as in Embodiment 1.

Testing of the Testing Batteries

Tests are conducted on the testing batteries with positive electrodes that are Embodiments 1 though 10 and the Comparison Examples to obtain the following data on the properties of said embodiments and comparison examples:

(a) High temperature cycling property, i.e., the discharge capacity in units of mAh at 60° C. A cycle is defined as using 1C rate of current (charge and discharge rate) to charge the battery to 4.2V and then using 1C rate of current to discharge the battery to 3.0V. At 60° C., for a particular cycle, the testing battery is charged and discharged to obtain the discharge capacity in units of mAh for that cycle;

(b) The 100 cycles residual capacity rate (%) at high temperature. This is equivalent to (the discharge capacity at the 100^{th} cycle at high temperature/the discharge capacity at the first cycle at high temperature)×100%; and

(c) Whether there is manganese sedimentation on the negative electrodes. The battery is dissected after 100 high temperature cycles. The negative electrode slice is taken out and dried. After drying, it is tested with an x-ray spectrometer to determine if there is Mn sedimentation on the negative electrode slice.

The test results are shown in table 1.

TABLE 1

| | | | | Capacity | Whether There |
|---|---|---|---|---|---|
| | The Single Sided | The Single Sided | | Residual Rate | is Manganese |
| | Thickness of | Thickness of | Whether There | After 100 High | Sedimentation |
| | First | Second | is Pressing After | Temperature | on the Negative |
| Sequence No. | Coating/mm | Coating/mm | First Coating | Cycles/% | Electrodes |
| Embodiment 1 | 0.115 | 0.005 | Yes | 57 | Abundant |
| Embodiment 2 | 0.110 | 0.010 | Yes | 72 | Little amount |
| Embodiment 3 | 0.110 | 0.010 | Yes | 81 | Not detectable |
| Embodiment 4 | 0.100 | 0.020 | Yes | 85 | Not detectable |
| Embodiment 5 | 0.100 | 0.020 | No | 86 | Not detectable |
| Embodiment 6 | 0.080 | 0.040 | No | 86 | Not detectable |
| Embodiment 7 | 0.060 | 0.060 | No | 85 | Not detectable |
| Embodiment 8 | 0.100 | 0.020 | No | 86 | Not detectable |
| Embodiment 9 | 0.100 | 0.020 | No | 84 | Not detectable |
| Embodiment 10 | 0.100 | 0.020 | No | 87 | Not detectable |
| Comparison | 0.120 | 0 | | 22 | Large amount |
| Example | | | | | |

Table 1 shows that, when the single sided thickness of the second layer of coating is greater than 0.01 mm, and especially when it is greater than 0.02 mm, the Mn sedimentation on the surface of the negative electrodes reduces significantly and the attenuation of the capacities at high temperature decreases significantly. However, as the single sided thickness of the second layer of coating increases, the quantity of the paste used for the second layer of coating also increases. This increase raises the cost of the battery. Therefore, the single sided thickness of the first layer of coating should be between 0.02 mm and 0.15 mm. The optimal range is between 0.05 mm and 0.12 mm. The single sided thickness of the second layer of coating should be between 0.01 mm and 0.06 mm. The optimal range is between 0.02 mm and 0.04 mm. In the embodiments described herein, the sum of single sided thickness of the first and the second layers of coating is 0.120 mm. The sum of single sided thickness of the first layer and the second layer of coating should be between 0.08 mm and 0.20 mm. The optimal range is between 0.10 mm and 0.16 mm.

Moreover, test results show that when the thickness of the second layers of coating is relatively small, Mn can be detected still on the surface of negative electrodes, when the positive electrodes of the embodiments does not undergo pressing after the first coating. Therefore, if the single sided thickness of the second layer of coating is less than 0.02 mm, it is preferable that the electrodes obtained after the first coating should undergo the pressing treatment. If the single sided thickness of the second layer of coating is greater than 0.02 mm, it is not necessary to press the negative electrode after the first coating.

While the present invention has been described with reference to certain preferred embodiments, it is to be understood that the present invention is not limited to such specific embodiments. Rather, it is the inventor's contention that the invention be understood and construed in its broadest meaning as reflected by the following claims. Thus, these claims are to be understood as incorporating not only the preferred embodiments described herein but all those other and further alterations and modifications as would be apparent to those of ordinary skilled in the art.

1. A positive electrode for lithium rechargeable batteries, comprising:
a current collector;
a first layer of coating comprising of a first active material on said current collector; and
a second layer of coating comprising of a second active material on said first layer of coating.

2. The positive electrode of claim 1 wherein said first active material for said first layer of coating is one or more active materials selected from the group consisting of: lithium manganese oxide, and lithium manganese oxide derivatives.

3. The positive electrode of claim 1 wherein said first active material for said first layer of coating is one or more active materials selected from the group consisting of: spinel lithium manganese oxide, and spinel lithium manganese oxide derivatives.

4. The positive electrode of claim 1 wherein said second active material for said second layer of coating is one or more active materials selected from the group consisting of: lithium cobalt oxide, lithium cobalt oxide derivatives, lithium nickel oxide and lithium nickel oxide derivatives.

5. The positive electrode of claim 3 wherein said second active material for said second layer of coating is one or more active materials selected from the group consisting of: lithium cobalt oxide, lithium cobalt oxide derivatives, lithium nickel oxide and lithium nickel oxide derivatives.

6. The positive electrode of claim 1 wherein the single sided thickness of said first layer of coating is between 0.02 mm and 0.15 mm.

7. The positive electrode of claim 1 wherein the single sided thickness of said second layer of coating is between 0.01 mm and 0.06 mm.

8. The positive electrode of claim 1 wherein the single sided thickness of said first layer of coating is between 0.05 mm and 0.12 mm and the single sided thickness of said second layer of coating is between 0.02 mm and 0.04 mm.

9. The positive electrode of claim 1 wherein the sum of the single sided thickness of said first layer of coating and the single sided thickness of said second layer of coating is between 0.08 mm and 0.20 mm.

10. The positive electrode of claim 1 wherein the sum of the single sided thickness of said first layer of coating and the single sided thickness of said second layer of coating is between 0.10 mm and 0.16 mm.

11. The positive electrode of claim 1 wherein said second active material in said second layer of coating is one or more lithium compounds selected from the group consisting of: LiCo₁₋ₓMₓO₂, and LiNi_{1-y}M_{y}O₂.

12. The positive electrode of claim 1 wherein said first active material in said first layer of coating is Li₁₊ₐMn_{2-b}N_{b}O₄.

13. The positive electrode of claim 11 wherein
the single sided thickness of said first layer of coating is between 0.02 mm and 0.15 mm; and
the single sided thickness of said second layer of coating is between 0.01 mm and 0.06 mm.

14. The positive electrode of claim 12 wherein
the single sided thickness of said first layer of coating is between 0.02 mm and 0.15 mm; and
the single sided thickness of said second layer of coating is between 0.01 mm and 0.06 mm.

15. The positive electrode of claim 11 wherein the sum of the single sided thickness of said first layer of coating and the single sided thickness of said second layer of coating is between 0.08 mm and 0.20 mm.

16. The positive electrode of claim 12 wherein the sum of the single sided thickness of said first layer of coating and the single sided thickness of said second layer of coating is between 0.08 mm and 0.20 mm.

17. A positive electrode for lithium rechargeable batteries, comprising:
a current collector,
a first layer of coating on said current collector; and
a second layer of coating on said first layer of coating; and wherein
the active material for said first layer of coating is one or more active materials selected from the group consisting of: spinel lithium manganese oxide, spinel lithium manganese oxide derivatives;
the active material for said second layer of coating is one of more active materials selected from the group consisting of: lithium cobalt oxide, lithium cobalt oxide derivatives, lithium nickel oxide and lithium nickel oxide derivatives;
the single sided thickness of said first layer of coating is between 0.02 mm and 0.15 mm;
the single sided thickness of said second layer of coating is between 0.01 mm and 0.06 mm; and
the sum of the single sided thickness of said first layer of coating and the single sided thickness of said second layer of coating is between 0.08 mm and 0.20 mm.

18. A method for fabricating a positive electrode, comprising the steps of:
applying a first layer of coating on a current collector;
drying said current collector with said first layer of coating;
applying a second layer of coating on of said current collector with said first layer of coating;
drying said current collector with said first and second layers of coating; and
pressing said dried current collector with said first and second layers of coating to obtain said positive electrode.

19. The method for fabricating a positive electrode of claim 18 wherein
said active material for said first layer of coating is one or more active materials selected from the following: spinel lithium manganese oxide, spinel lithium manganese oxide derivatives; and
said active material for said second layer of coating is one or more active materials selected from the following: lithium cobalt oxide, lithium cobalt oxide derivatives, lithium nickel oxide and lithium nickel oxide derivatives.

20. The method for fabricating a positive electrode of claim 18 wherein the following step is added after drying said current collector with first layer of coating and before applying a second layer of coating: pressing said dried current collector with said first layer of coating.

21. The method for fabricating a positive electrode of claim 18 wherein the single sided thickness of said first layer of coating is between 0.02 mm and 0.15 mm and the single sided thickness of said second layer of coating is between 0.01 mm and 0.06 mm.

22. The method for fabricating a positive electrode of claim 18 wherein the sum of the single sided thickness of said first layer of coating and the single sided thickness of said second layer of coating is between 0.08 mm and 0.20 mm.
